(19) United States
(12) Patent Application Publication
(10) Pub. No.: US 2026/0294102 A1
(43) Pub. Date: Oct. 1, 2026

(54) EXPANSION MESH AND WARDROBE FRAME

(71) Applicant: GAATU INC, TRACY, CA (US)

(72) Inventor: YUBIN PU, TRACY, CA (US)

(21) Appl. No.: 19/093,368

(22) Filed: Mar. 28, 2025

(51) Int. Cl. A47B 96/02; A47B 47/00

(52) U.S. Cl. CPC A47B 96/021; A47B 47/0091

(57) ABSTRACT

Provided are an expansion mesh and a wardrobe frame, which relate to the technical field of wardrobe frames. The expansion mesh includes: a mesh panel, sleeves, and a splicing and fixing assembly. The mesh panel includes a square frame surrounded by four support side frames and a bearing mesh surface arranged on the frame; the sleeves are arranged at two corners at one side of the mesh panel and configured to be sleeved and fixed on a support rod; and the splicing and fixing assembly is arranged on a support side frame at one side of the mesh panel not provided with the sleeves, and configured to splice and fix the support side frame at the side to a support side frame at one side of an adjacent mesh rack provided with the sleeves. The present invention has compact structures, smooth splicing and reduced manufacturing cost.

### FIELD OF THE DISCLOSURE

The present invention relates to the technical field of wardrobe frames, and in particular, to an expansion mesh and a wardrobe frame.

### BACKGROUND OF THE DISCLOSURE

A simple wardrobe, a convenient and practical storage furniture, may be used to store clothes, shoes, hats and other articles, and generally includes a wardrobe frame and a fabric cover mounted outside the wardrobe frame. The simple wardrobe is particularly suitable in environments where space is limited. The wardrobe frame generally includes four support rods and a mesh rack sleeved and fixed on the four support rods and provided with sleeves.

Most of the existing mesh racks are made of metal wires fixed and welded on a metal frame. The mesh rack is generally provided with a fixed length and width. Therefore, if a size of the simple wardrobe needs to be expanded, a plurality of mesh racks need to be spliced and fixed together, and sleeved on support rods by sleeves on the mesh racks, so that the size of the simple wardrobe may be increased. However, since the sleeve is provided with a certain thickness, when the size of the wardrobe is increased by splicing a plurality of mesh racks together, the sleeve makes a gap between two adjacent mesh racks too large, resulting in uneven mounting of a top mesh rack. Meanwhile, there are two rods at adjacent splicing positions, resulting in complex structures and high manufacturing cost.

Therefore, an expansion mesh and a wardrobe frame with compact structures, smooth splicing and reduced manufacturing cost need to be designed.

### SUMMARY OF THE DISCLOSURE

In view of the defects and shortcomings in the prior art, an objective of the present invention is to provide an expansion mesh and a wardrobe frame, which at least solve one of the technical problems and have the advantages of compact structure, smooth splicing and low manufacturing cost.

To achieve the foregoing objective, one aspect of the present invention provides an expansion mesh, which includes:
a mesh panel, including a square frame surrounded by four support side frames and a bearing mesh surface arranged on the frame;
sleeves, arranged at two corners at one side of the mesh panel and configured to be sleeved and fixed on a support rod; and
a splicing and fixing assembly, arranged on a support side frame at one side that is of the mesh panel and that is not provided with the sleeves, and configured to splice and fix the support side frame at the side to a support side frame at one side that is of an adjacent mesh rack and that is provided with the sleeves.

Optionally, the splicing and fixing assembly includes: a plurality of hook connectors and a corresponding number of thread locking assemblies;
the hook connector is fixedly arranged on an inner side of the support side frame, and a hook-shaped head of the hook connector is arranged towards an outer side of the support side frame; and
the thread locking assembly passes through the support side frame of the adjacent mesh rack and is in threaded connection with the hook connector.

Optionally, the hook connector includes: a hook connecting plate
and the hook-shaped head;
the hook connecting plate is welded and fixed on an inner side of the support side frame, and passes through a top of the support side frame and is bent outward to form the hook-shaped head;
the thread locking assembly includes: a first large head screw, a washer and a first cap; and
the first large head screw passes through the washer, the support side frame of the adjacent mesh rack, the support side frame at the side that is of the mesh panel and that is not provided with the sleeves, and the hook connecting plate in sequence, and is in threaded connection with the first cap.

Optionally, the plurality of hook connectors and the corresponding number of thread locking assemblies are arranged at intervals along a length direction of the support side frame, so that the support side frame at the side is spliced and fixed with the support side frame of the adjacent mesh rack.

Optionally, the splicing and fixing assembly includes: a plurality of C-shaped buckling members, a corresponding number of pressing plates, and a corresponding number of thread fixing assemblies; and
the C-shaped buckling member and the pressing plate are configured to wrap and dock the support side frame at the side that is not provided with the sleeves with the support side frame of the adjacent mesh rack, and are locked and fixed by the thread fixing assembly.

Optionally, the thread fixing assembly includes: a second large head screw and a second cap; and
the second large head screw passes through the pressing plate, the support side frame of the adjacent mesh rack, the support side frame at the side that is of the mesh panel and that is not provided with the sleeves, and the C-shaped buckling member, and is in threaded connection with the second cap.

Optionally, the plurality of C-shaped buckling members, the pressing plates and the thread fixing assemblies are arranged at intervals along a length direction of the support side frame, so that the support side frame at the side is spliced and fixed with the support side frame of the adjacent mesh rack.

Optionally, the expansion mesh further includes an intermediate sleeve; and the intermediate sleeve is arranged in a middle of the support side frame at one side that is provided with the sleeves and is configured to be sleeved and fixed with a middle support rod.

Optionally, the support side frame includes a top rod, a bottom rod, and a connecting curved rod arranged between the top rod and the bottom rod and in a triangular wavy line shape; the bearing mesh surface is composed of a plurality of metal wires welded on the support side frame in a criss-cross mode; and the sleeve is a conical sleeve with an upper aperture smaller than a lower aperture.

Another aspect of the present invention provides a wardrobe frame, which includes: a basic mesh rack provided with sleeves at four corners and the expansion mesh described above; the expansion mesh is spliced and fixed with a support side frame at one side of the basic mesh rack by the splicing and fixing assembly; and the expansion mesh and the sleeves of the expansion mesh are sleeved and fixed at a top and a bottom of a support rod.

Compared with the prior art, the present invention has the following advantages.

The mesh panel is only provided with sleeves at two corners on one side and includes a splicing and fixing assembly. Therefore, when the expansion mesh needs to be spliced to an adjacent mesh rack, a support side frame at one side that is not provided with the sleeves is spliced and fixed with a support side frame at one side that is of the adjacent mesh rack and that is provided with the sleeves by the splicing and fixing assembly. Therefore, a gap of a thickness of one sleeve may be reduced at the splicing position, so that the spliced wardrobe frame mesh rack has a compact structure, and the phenomenon of uneven splicing caused by a difference in a taper between two sleeves may be avoided; meanwhile, two sleeves are reduced to further reduce the manufacturing materials and costs, which has the advantage of reducing manufacturing costs.

### BRIEF DESCRIPTION OF THE DRAWINGS

To more clearly illustrate the technical solution in the embodiments of the present invention or in the prior art, the accompanying drawings required to be used in the description of the embodiments or the prior art are briefly introduced below. It is obvious that the accompanying drawings in the description below are only embodiments of the present invention, and those of ordinary skill in the art can obtain other accompanying drawings according to these accompanying drawings without creative efforts.

FIG. 1 is a schematic structural diagram of a wardrobe frame according to Embodiment 1 of the present invention;

FIG. 2 is a partially enlarged view of A in FIG. 1;

FIG. 3 is an exploded schematic diagram of a partial structure of an expansion mesh according to Embodiment 1 of the present invention;

FIG. 4 is a schematic diagram of an exploded structure of a splicing and fixing assembly according to Embodiment 1 of the present invention;

FIG. 5 is a schematic structural diagram of a wardrobe frame according to Embodiment 2 of the present invention;

FIG. 6 is a partially enlarged view of B in FIG. 5.

FIG. 7 is an exploded schematic diagram of a partial structure according to Embodiment 2 of the present invention;

FIG. 8 is an exploded schematic diagram of a partial structure of an expansion mesh according to Embodiment 2 of the present invention; and

FIG. 9 is a schematic diagram of an exploded structure of a splicing and fixing assembly according to Embodiment 2 of the present invention.

### DESCRIPTIONS OF REFERENCE NUMERALS

1000: wardrobe frame;
100: expansion mesh;
1: mesh panel; 11: frame; 111: support side frame; 112: top rod; 113: bottom rod; 114: connecting curved rod; 12: bearing mesh surface;
2: sleeve;
3: intermediate sleeve;
41: hook connector; 411: hook connecting plate; 412: hook-shaped head; 42: thread locking assembly; 421: first large head screw; 422: washer; 423: first cap;
51: C-shaped buckling member; 52: pressing plate; 53: thread fixing assembly;
531: second large head screw; 532: second cap;
200: basic mesh rack; and
210: support rod.

### DETAILED DESCRIPTION OF THE EXEMPLARY EMBODIMENTS

The technical solutions in the embodiments of the present invention are clearly and fully described below with reference to the accompanying drawings in the embodiments of the present invention.

### Embodiment 1

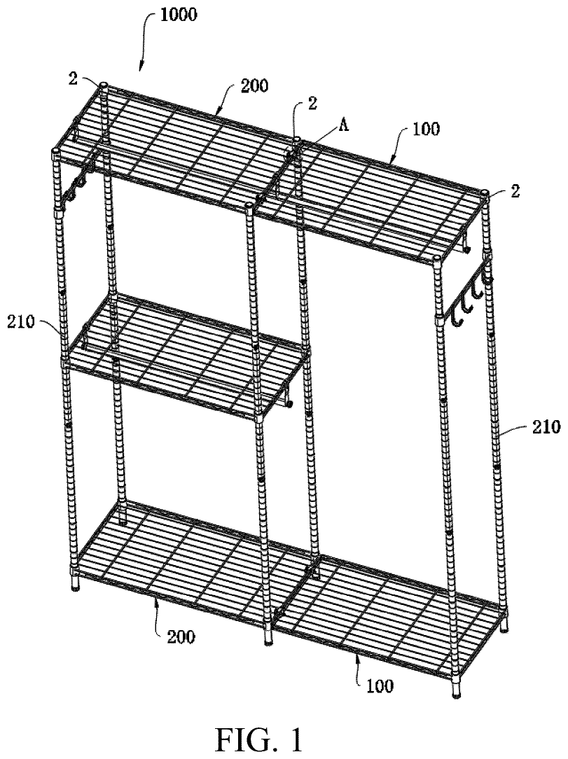

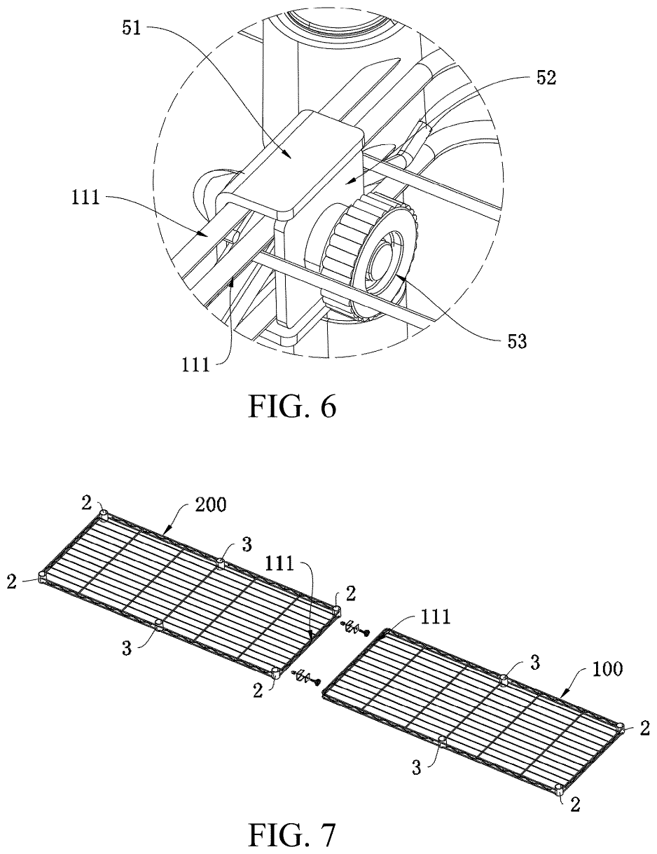

Referring to FIGS. 1 to 9, an embodiment of the present invention provides an expansion mesh 100, which includes: a mesh panel 1, sleeves 2, and a splicing and fixing assembly.

The mesh panel 1 includes: a frame 11 and a bearing mesh surface 12. The frame 11 is square and is surrounded by four support side frames 111. The bearing mesh surface 12 is arranged on the frame 11, and is configured to support and store clothes, or hang hangers after the wardrobe frame 1000 is formed.

The sleeves 2 are arranged at two corners at one side of the mesh panel 1 and configured to be sleeved and fixed on a support rod 210. That is, the sleeves 2 are arranged at a corner region where a shorter support side frame 111 at one side is connected to two longer support side frames 111. Specifically, the sleeves are arranged at two corners at one side of the mesh panel 1 by welding.

The splicing and fixing assembly is arranged on a support side frame 111 at one side that is of the mesh panel 1 and that is not provided with the sleeve 2, and is configured to splice and fix the support side frame 111 at the side to a support side frame 111 at one side that is of an adjacent mesh rack and that is provided with the sleeves 2. The splicing and fixing assembly may be detachable, or may be fixedly arranged on the support side frame 111 at one side that is of the mesh panel 1 and that is not provided with the sleeves 2. When a size of the wardrobe frame 1000 needs to be increased, the support side frame 111 at the side that is of the mesh panel 1 of the expansion mesh 100 and that is not provided with the sleeves 2 is spliced and fixed with a support side frame 111 at one side that is of an adjacent mesh rack and that is provided with the sleeves 2 by the splicing and fixing assembly, and a corresponding support rod 210 is sleeved at the position of the sleeve 2. It may be understood that the adjacent mesh rack may be a basic mesh rack 200 provided with the sleeves 2 at four corners, or another expansion mesh 100. This is not specifically limited herein.

The mesh panel 1 is only provided with sleeves 2 at two corners on one side and includes a splicing and fixing assembly. Therefore, when the expansion mesh 100 needs to be spliced to an adjacent mesh rack, a support side frame 111 at one side that is not provided with the sleeves 2 is spliced and fixed with a support side frame 111 at one side that is of the adjacent mesh rack and that is provided with the sleeves 2 by the splicing and fixing assembly. Therefore, a gap of a thickness of one sleeve 2 may be reduced at the splicing position, so that the spliced mesh rack of the wardrobe frame 1000 has a compact structure, and the phenomenon of uneven splicing caused by a difference in a taper between two sleeves 2 may be avoided; meanwhile, two sleeves 2 are reduced to further reduce the manufacturing materials and costs, which has the advantage of reducing manufacturing costs.

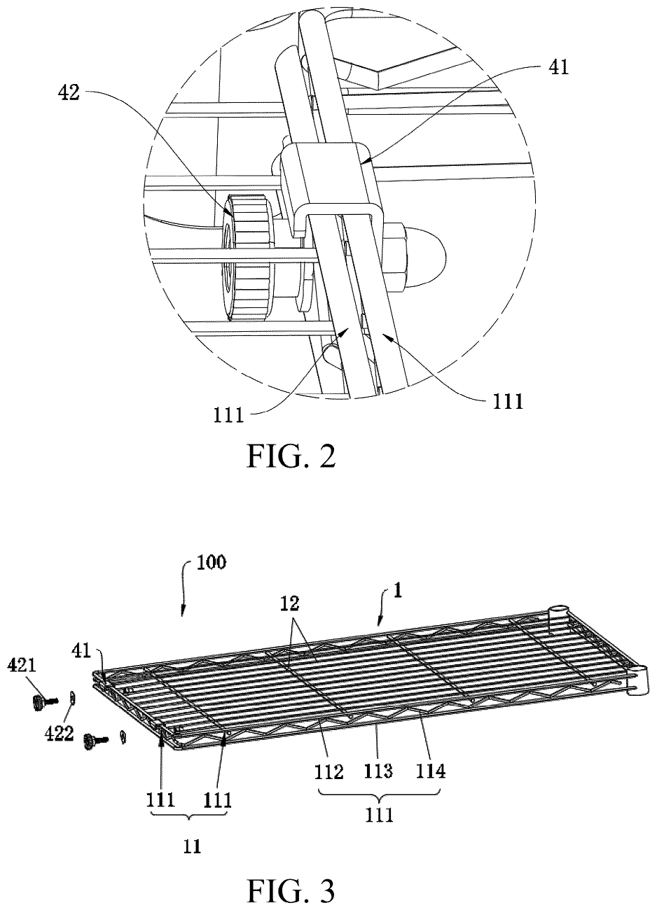

To achieve the quick splicing between the mesh panel 1 and the adjacent mesh rack, optionally, referring to FIG. 2 to 4, in this embodiment, the splicing and fixing assembly includes: two hook connectors 41 and two thread locking assemblies 42. The hook connector 41 is fixedly arranged on an inner side of the support side frame 111, and a hook-shaped head 412 of the hook connector is arranged towards an outer side of the support side frame 111. The thread locking assembly 42 passes through the support side frame 111 of the adjacent mesh rack and is in threaded connection with the hook connector 41. In this way, the hook connector 41 is quickly engaged to the support side frame 111 of the adjacent mesh rack provided with the sleeve 2 by using the hook-shaped head 412. When the hook connector 41 engages the mesh panel 1 to the support side frame 111 of the adjacent mesh rack, the support side frame 111 at one side that is of the expansion mesh 100 and that is not provided with the sleeves 2 and the support side frame 111 of the adjacent mesh rack are locked on the hook connector 41 by the thread locking assembly 42 for fixing. Of course, in other embodiments, the number of the hook connectors 41 and the thread locking assemblies 42 is not limited to two, and may be one, three, four or more, as long as the quick connection between the mesh panel 1 and the adjacent mesh rack may be achieved.

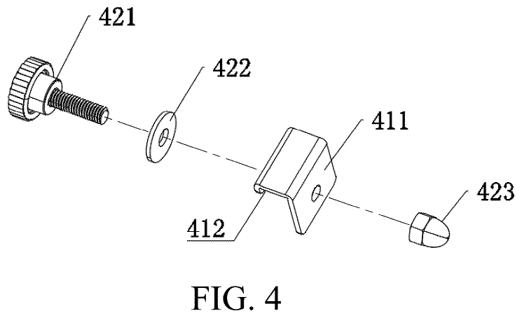

Optionally, referring to FIG. 4, in this embodiment, the hook connector 41 includes a hook connecting plate 411 and a hook-shaped head 412. The thread locking assembly 42 includes a first large head screw 421, a washer 422, and a first cap 423.

The hook connecting plate 411 is welded and fixed on an inner side of the support side frame 111, and passes through a top of the support side frame 111 and is bent outward to form the hook-shaped head 412. When the hook connector 41 engages the mesh panel 1 to the support side frame 111 of the adjacent mesh rack by the hook-shaped head 412, the first large head screw 421 passes through the washer 422, the support side frame 111 of the adjacent mesh rack, the support side frame 111 at the side that is of the mesh panel 1 and that is not provided with the sleeves 2, and the hook connecting plate 411 in sequence, and is in threaded connection with the first cap 423.

To achieve more stable splicing between the expansion mesh 100 and the adjacent mesh rack, optionally, referring to FIG. 3, in this embodiment, two hook connectors 41 and two thread locking assemblies 42 are arranged at intervals along a length direction of the support side frame 111, so that the support side frame 111 at the side is spliced and fixed with the support side frame 111 of the adjacent mesh rack. Of course, in other embodiments, the number of the hook connectors 41 and the thread locking assemblies 42 is not limited to two, and may be arranged at intervals along a length direction of the support side frame 111 when the number is greater than or equal to two.

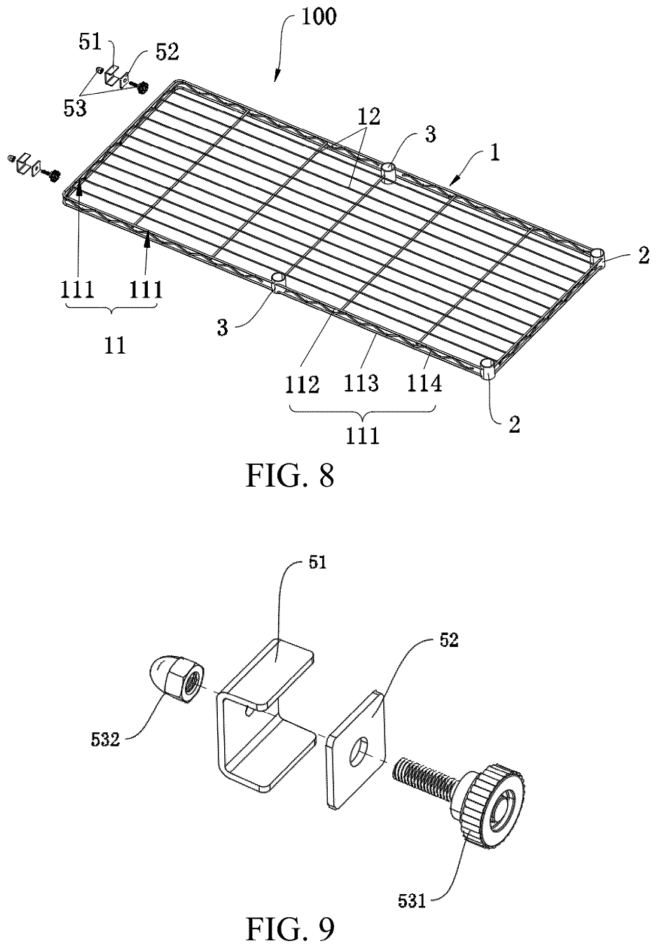

When a length of the mesh panel 1 is long, to avoid the mesh panel 1 from being bent due to excessive weight of clothes, which causes the expansion mesh 100 to be unstable, optionally, referring to FIG. 8, in this embodiment, the expansion mesh 100 further includes an intermediate sleeve 3; and the intermediate sleeve 3 is arranged in a middle of the support side frame 111 at one side that is provided with the sleeves 2 and is configured to be sleeved and fixed with a middle support rod 210. This is equivalent to adding a support point, which distributes the pressure on the mesh panel 1 and prevents the mesh panel 1 from being bent due to excessive weight of clothes. Of course, in other embodiments, a plurality of expansion meshes 100 may be spliced in sequence to obtain a desired length. This is not specifically limited herein.

Optionally, referring to FIG. 3, in this embodiment, the support side frame 111 includes a top rod 112, a bottom rod 113, and a connecting curved rod 114 arranged between the top rod 112 and the bottom rod 113 and in a triangular wavy line shape. Specifically, the top rod 112 and the bottom rod 113 may be made of steel or alloy. The curved rod may be made of steel or alloy wire, which is welded between the top rod 112 and the bottom rod 113 by bending. In this way, the support strength of the mesh panel 1 may be improved. The bearing mesh surface 12 is composed of a plurality of metal wires welded on the support side frame 111 in a criss-cross mode. The sleeve 2 is a conical sleeve with an upper aperture smaller than a lower aperture. Therefore, the sleeve 2 may be conveniently sleeved and fixed on a fixed sleeve 2 (not shown) provided with a tapered outer peripheral surface corresponding to the support rod 210.

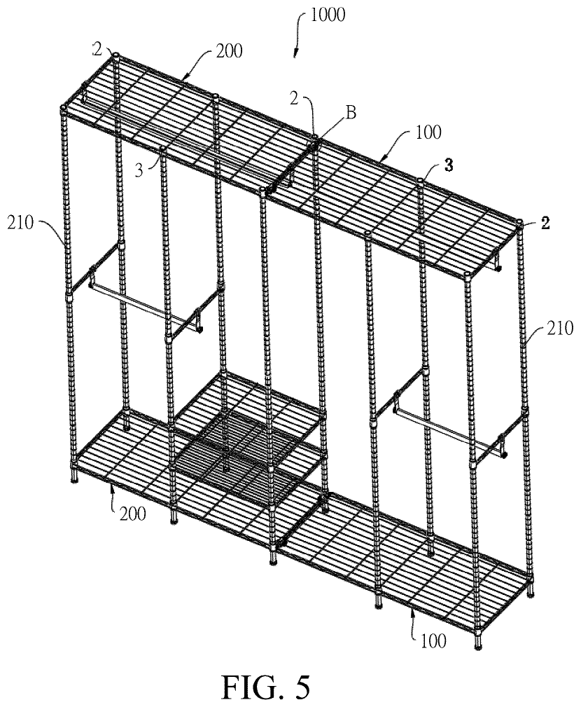

Referring to FIGS. 1 and 5, another aspect of the embodiment of the present invention provides a wardrobe frame 1000, which includes: a basic mesh rack 200 provided with sleeves 2 at four corners and the expansion mesh 100 described above. The expansion mesh 100 is spliced and fixed with the support side frame 111 at one side of the basic mesh rack 200 by the splicing and fixing assembly. The expansion mesh 100 and the sleeve 2 of the expansion mesh 100 are sleeved and fixed at a top and a bottom of the support rod 210. It may be understood that the structure of the basic mesh rack 200 is basically the same as that of the expansion mesh 100, except that the four corners of the mesh panel 1 of the basic mesh rack 200 are provided with sleeves 2. Since the wardrobe frame 1000 has all the structures and connections of the expansion mesh 100, the wardrobe frame has all the advantages of the expansion mesh 100. Details are not described herein.

### Embodiment 2

This embodiment is basically the same as Embodiment 1, and the differences only include the specific structure of the splicing and fixing assembly and the connection method with the support side frame 111 at the side that is of the mesh panel 1 and that is not provided with the sleeves 2.

Optionally, referring to FIGS. 5 to 9, in this embodiment, the splicing and fixing assembly includes: two C-shaped buckling members 51, two pressing plates 52, and two thread fixing assemblies 53.

The C-shaped buckling member 51 and the pressure plate 52 are configured to wrap and dock the support side frame 111 with the support side frame 111 of the adjacent mesh rack, and are locked and fixed by the thread fixing assembly 53. That is, the support side frame 111 at the side that is of the expansion mesh 100 and that is not provided with the sleeves 2 and the support side frame 111 of the adjacent mesh rack are close to each other by the C-shaped buckling member 51 and the pressing plate 52, are limited in a space limited by the C-shaped buckling member 51 and the pressing plate 52, and are locked and fixed by the thread fixing assembly 53.

Specifically, the thread fixing assembly 53 includes: a second large head screw 531 and a second cap 532. The second large head screw 531 passes through the pressing plate 52, the support side frame 111 of the adjacent mesh rack, the support side frame 111 at the side that is of the mesh panel 1 and that is not provided with the sleeves 2, and the C-shaped buckling member 51, and is in threaded connection with the second cap 532. Therefore, the expansion mesh 100 and the adjacent mesh rack may be spliced quickly and stably.

Optionally, referring to FIG. 8, in this embodiment, the plurality of C-shaped buckling members 51, the pressing plates 52 and the thread fixing assemblies 53 are arranged at intervals along a length direction of the support side frame 111, so that the support side frame 111 at the side is spliced and fixed with the support side frame 111 of the adjacent mesh rack. This makes the splicing between the expansion mesh 100 and the adjacent mesh rack more stable.

The foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of embodiments of the present disclosure.

What is claimed is:

1. An expansion mesh, comprising:
a mesh panel, comprising a square frame surrounded by four support side frames and a bearing mesh surface arranged on the frame;
sleeves, arranged at two corners at one side of the mesh panel and configured to be sleeved and fixed on a support rod; and
a splicing and fixing assembly, arranged on a support side frame at one side that is of the mesh panel and that is not provided with the sleeves, and configured to splice and fix the support side frame at the side to a support side frame at one side that is of an adjacent mesh rack and that is provided with the sleeves.

2. The expansion mesh according to claim 1, wherein the splicing and fixing assembly comprises: a plurality of hook connectors and a corresponding number of thread locking assemblies;
the hook connector is fixedly arranged on an inner side of the support side frame, and a hook-shaped head of the hook connector is arranged towards an outer side of the support side frame; and
the thread locking assembly passes through the support side frame of the adjacent mesh rack and is in threaded connection with the hook connector.

3. The expansion mesh according to claim 2, wherein the hook connector comprises: a hook connecting plate and the hook-shaped head;
the hook connecting plate is welded and fixed on an inner side of the support side frame, and passes through a top of the support side frame and is bent outward to form the hook-shaped head;
the thread locking assembly comprises: a first large head screw, a washer and a first cap; and
the first large head screw passes through the washer, the support side frame of the adjacent mesh rack, the support side frame at the side that is of the mesh panel and that is not provided with the sleeves, and the hook connecting plate in sequence, and is in threaded connection with the first cap.

4. The expansion mesh according to claim 2, wherein the plurality of hook connectors and the corresponding number of thread locking assemblies are arranged at intervals along a length direction of the support side frame, so that the support side frame at the side is spliced and fixed with the support side frame of the adjacent mesh rack.

5. The expansion mesh according to claim 1, wherein the splicing and fixing assembly comprises: a plurality of C-shaped buckling members, a corresponding number of pressing plates, and a corresponding number of thread fixing assemblies; and
the C-shaped buckling member and the pressing plate are configured to wrap and dock the support side frame at the side that is not provided with the sleeves with the support side frame of the adjacent mesh rack, and are locked and fixed by the thread fixing assembly.

6. The expansion mesh according to claim 5, wherein the thread fixing assembly comprises: a second large head screw and a second cap; and
the second large head screw passes through the pressing plate, the support side frame of the adjacent mesh rack, the support side frame at the side that is of the mesh panel and that is not provided with the sleeves, and the C-shaped buckling member, and is in threaded connection with the second cap.

7. The expansion mesh according to claim 5, wherein the plurality of C-shaped buckling members, the pressing plates and the thread fixing assemblies are arranged at intervals along a length direction of the support side frame, so that the support side frame at the side is spliced and fixed with the support side frame of the adjacent mesh rack.

8. The expansion mesh according to claim 1, further comprising an intermediate sleeve; wherein the intermediate sleeve is arranged in a middle of the support side frame at one side that is provided with the sleeves and is configured to be sleeved and fixed with a middle support rod.

9. The expansion mesh according to claim 1, wherein the support side frame comprises a top rod, a bottom rod, and a connecting curved rod arranged between the top rod and the bottom rod and in a triangular wavy line shape; the bearing mesh surface is composed of a plurality of metal wires welded on the support side frame in a criss-cross mode; and the sleeve is a conical sleeve with an upper aperture smaller than a lower aperture.

10. A wardrobe frame, comprising: a basic mesh rack provided with sleeves at four corners and the expansion mesh according to claim 1; wherein the expansion mesh is spliced and fixed with a support side frame at one side of the basic mesh rack by the splicing and fixing assembly; and the expansion mesh and sleeves of the expansion mesh are sleeved and fixed at a top and a bottom of a support rod.
